(19) United States
(12) Patent Application Publication
(10) Pub. No.: US 2008/0125123 A1
(43) Pub. Date: May 29, 2008

(54) METHOD AND SYSTEM FOR TO ENABLE COMMUNICATION FOR A WIRELESS DEVICE HAVING A PLURALITY OF IDENTIFIERS

(75) Inventors: Jheroen P. Dorenbosch, Paradise, TX (US); Srinivas Miryala, Gurgaon (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/563,345

(22) Filed: Nov. 27, 2006

(51) Int. Cl. H04Q 7/20

(52) U.S. Cl. 455/436

(57) ABSTRACT

A method and systems for communication between a first device migrated from a second communication network to a first communication network and a second device in a second communication network is provided. The first device uses a first Identifier (ID) in the first communication network and the second device uses a second ID in the second communication network. The method includes associating the first ID and a third ID. The third ID identifies the first device in the second communication network. The method further includes storing the association between the first ID and the third ID. Thereafter, a communication is established from the first device to the second device based on the association between the first ID and the third ID.

### FIELD OF THE INVENTION

The invention generally relates to a method and system for communication between a first communication network and a second communication networks, and more particularly to enabling communication for a wireless communication device having a plurality of Identifiers (IDs).

### BACKGROUND OF THE INVENTION

In existing systems, communication between a first communication network and the second communication network is enabled by a registrar. The technologies used by the first communication network and the second communication network may be different. For example, the first communication network may be a Third Generation (3G) communication network using a 3G technology and the second communication network maybe an Integrated Digital Enhanced Network (iDEN™) communication network. In this case, the registrar may be a Session Initiation Protocol (SIP) registrar. Communication devices may roam and may migrate between the first communication network and the second communication network. The registrar enables communication by storing location information corresponding to communication devices. A communication device that roams between the second communication network and the first communication networks must support the technology used by the first communication network and the technology used by the second communication network. If the first communication network and the second communication network use different technologies, then the communication device must be a dual-mode device. However, if the first communication network and the second communication network use the same technology, then the communication device may be a single-mode device. The registrar enables communication for roaming communication devices by storing location information corresponding to the communication devices.

A user is said to migrate from a second communication device in the second communication network to a first communication device in the first communication networks, if the user replaces the first communication device with the second communication device. This is normally done when the technology used by the first communication network is advanced as compared to the technology used by the second communication network. Such a migration may be referred to as the migration of the second communication device to the first communication device. The migration may also be referred to as the migration of the user from the second communication network to the first communication network. Alternately, the migration may also be referred to as the migration to the first device.

As an example of the scenario given above, the second communication device associated with the second communication network, which is an iDEN communication network, may migrate to a first communication device in the first communication network, which is a 3G communication network. The first communication device may be a dual-mode device that is capable of communicating in each of the 3G communication network and the iDEN communication network. The first communication device may also be a single-mode device that is capable of communicating in the 3G communication network. The second communication device may be capable of communicating in the iDEN communication network only. The 3G communication network is a packet based network that supports data transfer, interconnect calls, and dispatch calls. The iDEN communication network is a network that supports half duplex dispatch calls and interconnect calls. The second communication device, which is the migrated-from communication device, uses an iDEN Identifier (ID) to identify itself in the iDEN communication network and to communicate dispatch calls in the iDEN communication network. Examples of an iDEN ID may include but are not limited to, a Universal Fleet Mobile Identifier (UFMI), and a fleet ID.

The first communication device uses a 3G ID to identify itself in the 3G communication network as the first communication device cannot use the original iDEN ID to communicate in the 3G communication network. The first communication device uses its 3G ID to identify itself when communicating with communication devices associated with 3G communication network. However, to communicate with communication devices associated with iDEN communication network, the first communication device has to use the original iDEN ID to identify itself. Therefore, when an iDEN communication device associated with the iDEN communication network initiates a session or a call to the first communication device using the original iDEN ID of the first communication device after it has migrated to the 3G communication network, then the session or the call may not be connected as the first communication device is using the 3G ID in the 3G communication network.

Further, when the first communication device, which has migrated from the second communication network to the first communication network, uses the 3G ID to identify itself when it initiates a call to and intended for the iDEN communication device in the iDEN communication network, the call is routed to the iDEN communication device in the iDEN communication network. After the call is connected to the iDEN communication device, the 3G ID is provided to be displayed on the iDEN communication device. However, as the 3G ID is not compatible with the iDEN communication network the display of the caller ID may fail. Moreover, if the iDEN communication device needs to call back to the first communication device that has migrated to the 3G communication network using the 3G ID to identify the first communication device, then the call back is not connected because the iDEN communication network is not able to route calls based on a 3G ID.

### BRIEF DESCRIPTION OF THE FIGURES

The accompanying figures, where like reference numerals refer to identical or functionally similar elements throughout the separate views and together with the detailed description below are incorporated in and form part of the specification, serve to further illustrate various embodiments and to explain various principles and advantages all in accordance with the invention.

FIG. 1 is a block diagram showing an environment (that is exemplary) for the invention to function.

FIG. 2 is a block diagram showing a system for communication between a first communication network and a second communication network, in accordance with an embodiment of the invention.

FIG. 3 is a block diagram showing an apparatus for facilitating communication between a first device in a first communication network and a second device in a second communication network, in accordance with an embodiment of the invention.

FIG. 4 is a flowchart of a method of communication between a first device in a first communication network and a second device in a second communication network, in accordance with an embodiment of the invention.

FIG. 5 is a flowchart of a method for establishing a communication between a first device and a second device, in accordance with an embodiment of the invention.

FIG. 6 is a flowchart of a method for routing a first call from a first device to a second device, in accordance with an embodiment of the invention.

FIG. 7 is a flowchart of a method for routing a first call from the first device to a second device, in accordance with another embodiment of the invention.

FIG. 8 is a flowchart of a method for establishing a communication between a first device and a second device, in accordance with another embodiment of the invention.

FIG. 9 is a flowchart of a method for routing a second call from the second device to a first device, in accordance with another embodiment of the invention.

FIG. 10 is a flowchart of a method for establishing a communication between a first device and a second device, in accordance with another embodiment of the invention.

FIG. 11 is a flowchart of a method for establishing communication between a first device and a third device, in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to a method for enabling communication for a wireless communication device having a plurality of identifiers. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the mobile station. The non-processor circuits may include, but are not limited to, a radio receiver, a radio transmitter, signal drivers, clock circuits, power source circuits, and user input devices. As such, these functions may be interpreted as steps of a method for enabling communication for a wireless communication device having a plurality of identifiers. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments of the invention provide methods and systems for communication between a first device migrated from a second communication network to a first communication network and a second device in the second communication network. The first device uses a first Identifier (ID) in the first communication network and the second device uses a second ID in the second communication network. The method includes associating the first ID and a third ID. The third ID identifies the first device in the second communication network. The method further includes storing the association between the first ID and the third ID. Thereafter, a communication is established from the first device to the second device based on the association between the first ID and the third ID.

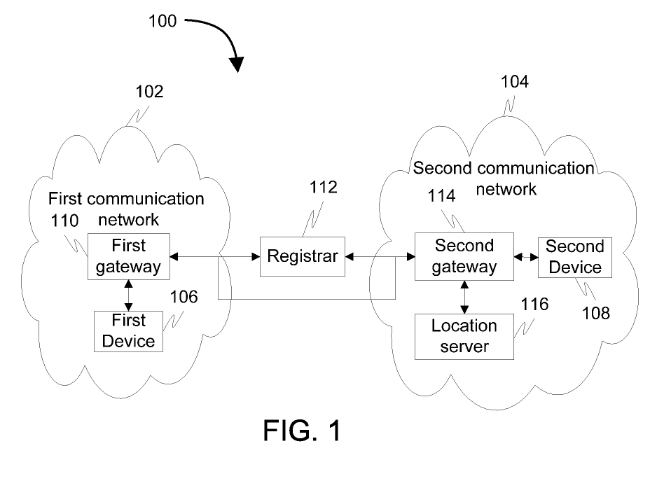

FIG. 1 is a block diagram showing a wireless communication system 100 in which various embodiments of the invention can function. The wireless communication system 100 includes a first communication network 102 and a second communication network 104. The first communication network 102, for example, may be one of, but not limited to a 3G system, a Fourth Generation (4G) systems, Worldwide Interoperability for Microwave Access (WiMax) system, Wireless Fidelity (WiFi) systems, High-Speed Downlink Packet Access (HSDPA) systems, and High-Speed Uplink Packet Access (HSUPA) systems and the second communication network 104, for example, may be one of, but not limited to, Integrated Digital Enhanced Network (iDEN™), Global System for Mobile communication (GSM) system, Digital Advanced Mobile Phone System (D-AMPS), Code Division Multiple Access one (CDMAOne) system, Personal Digital Communication (PDC) systems, Circuit Switched Data (CSD) system. The wireless communication system 100 further includes a first device 106 and a second device 108. The first device 106 is associated with the first communication network 102 and uses the communication services provided by the first communication network 102. Similarly, the second device 108 is associated with the second communication network 104 and uses the communication services provided by the second communication network 104. Nonetheless, the first device 106 may also be configured to also operate in the second communication network 104. The user of the first device 106 may also have migrated from a third device that was used by the user to operate in the second communication network 104. Those of skilled in the art would appreciate that the wireless communication system 100 may include more than two devices. Examples devices may include, but are not limited to, a cell phone, a pager, a laptop, a personal computer, and a Personal Digital Assistant (PDA).

When the first device 106 is roaming or appears to be roaming (due to its migration) in the second communication network 104, then a first gateway 110 or other routing entity in the first communication network 102 and a second gateway 114 or other routing entity in the second communication network 104 route a call initiated to and intended for the first device 106 from the second communication network 104 using location information obtained from a registrar 112. The registrar 112 stores location information for one or more communication devices which roam within the first communication network 102 or roam within other networks, such as the second communication network 104. For example, a device may roam from the first communication network 102 into the second communication network 104. The registrar 112 stores location information corresponding to the device where the location information is used to reach the device in the second communication network 104. The first gateway 110 or other routing elements in the first communication network 102 that need to route a call to the device roamed into the second communication network 104 can obtain and use the location information stored for the device in the registrar 112 and route the call to a second gateway 114 in the second communication network 104. Thereafter, the second gateway 114 connects the call to the device roaming in the second communication network 104. In another example, a device may roam or migrate from the second communication network 104 into the first communication network 102. The registrar 112 stores location information corresponding to the device where the location information is used to reach the device in the first communication network 102. The second gateway 114 or an other routing element in the second communication network 104 that needs to route a call to the device roamed into the first communication network 102 can obtain and use the location information stored for the device in the registrar 112 and route the call to the first gateway 110 in the first communication network 102. Thereafter, the first gateway 110 connects the call to the device in the first communication network 102.

The registrar 112 or a second registrar (not shown in FIG. 1), thus, may store location information for one or more devices corresponding to the second communication network 104, which roam or migrate to the first communication network 102. The communication network 104 may use a location server 116 within the second communication network 104 in order to establish a call to a target device corresponding to the second communication network 104 that is associated with and located in or appears to be located in the second communication network 104, such as the second device 108. To route such a call, the location server 116 is queried to determine location of the target device 108. The location server 116 may be a Home Location Registrar (HLR) for an iDEN™ system. Thereafter, based on the location information of the second device 108, the call is connected to the second device 108 in the second communication network 104.

If the second device 108 roams or migrates from the second communication network 104 to the first communication network 102, the registrar 112 will include location information for the second device 108 in the first communication network 102. In this case, to establish a call to the second device 108 from an originating communication device in the second communication network 104, the second gateway 114 queries the registrar 112 to obtain the location information for the second device 108. The location information may point to the first gateway 110 in the first communication network 102. Thereafter, the second gateway 114 routes the call to the first gateway 110 based on the location information stored in the registrar 112 corresponding to the second device 108. The first gateway 110 connects the call to the second device 108, which is roaming in or has migrated to the first communication network 102

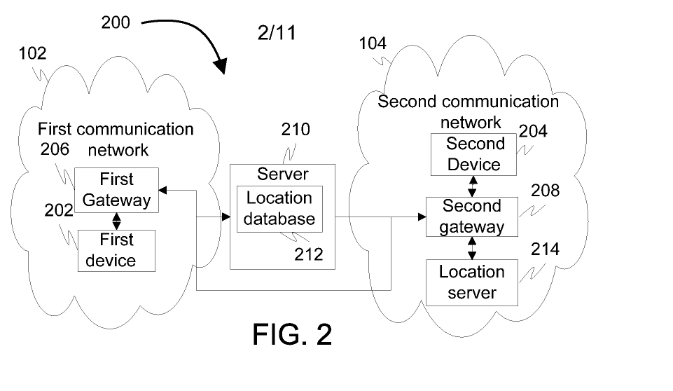

FIG. 2 is a block diagram showing a system 200 for communication between the first communication network 102 and the second communication network 104 according to an embodiment of the invention. The system 200 includes a first device 202 that uses the communication services provided by the first communication network 102, a second device 204 that uses the communication services provided by the second communication network 104, a first gateway 206 associated with the first communication network 102, and a second gateway 208 associated with the second communication network 104. The first communication network 102 may be one of a 3G communication network 4Gsystems, WiMax system, WiFi system, HSDPA system, and HSUPA system, and the second communication network 104 may be one of, but not limited to an iDEN™ system, GSM system, D-AMPS systems, CDMAOne systems, PDC systems, CSD systems.

The first device 202 has migrated to first communication network 102. In other words, a user of the first device replaced a third device (not shown in FIG. 2), the migrated-from device, which the user previously operated in the second communication network 104, with the first device 202, which is the migrated-to device. The user of the first device 202 identified itself by a third ID in the second communication network 104 to communicate with devices in the second communication network 104 and, hence, the third ID identifies the first device 202 in the second communication network 104. After migration, the first device 202 uses a first ID in the first communication network 102 to communicate with devices in the first communication network 102. The user of the first device 202 initially may have used the third device, which is compatible only with the second communication network 104, to communicate with devices in the second communication network 104, and thereafter, the user may have migrated to the first communication network 102 and used the first device 202, which is compatible only with the first communication network 102, to communicate with devices in the first communication network 102. The first device 202 may also be a dual-mode communication device identified by a third ID in the second communication network 104, which has roamed to the first communication network 102. While roaming, the first device 202 uses a first ID in the first communication network 102 to communicate with devices in the first communication network 102. The first ID, for example, may be, a 3G ID, such as a Session Initiation Protocol (SIP) Universal Resource Identifier (URI), a SIPS URI, an absolute URI, an Internet Protocol (IP) address, if the first communication network 102 is one of, but not limited to, a 3G communication network 4G systems, WiMax systems, WiFi systems, HSDPA systems, and HSUPA systems. The third ID, for example, may be a Universal Fleet Mobile Identifier (UFMI) or a temporary ID, a phone number, a fleet ID and an International Mobile Equipment Identity (IMEI), if the second communication network 104 is one of, but not limited to, an iDEN™ system, GSM system, D-AMPS, CDMAOne system, PDC systems, CSD system.

The user of the first device 202 has roamed or migrated from the second communication network 104 to the first communication network 102. To enable the first device 202 in the first communication network 102 to communicate with the second device 204 in the second communication network 104, the first ID is associated with the third ID so that the user of the first device 202 is able to communicate with devices in the second communication network 104 when the first device 202 is located in the first communication network 102. Accordingly, the first device 202 is known by the third ID to devices operating in the second communication network 104, and calls between the first device 202 and devices operating in the second communication network 104 are made by associating the first ID and the third ID. The resulting association between the first ID and the third ID and therefore between the third ID and the first ID—implies that the first device is identified by the first ID in the first communication network 102 and by the third ID in the second communication network 104.

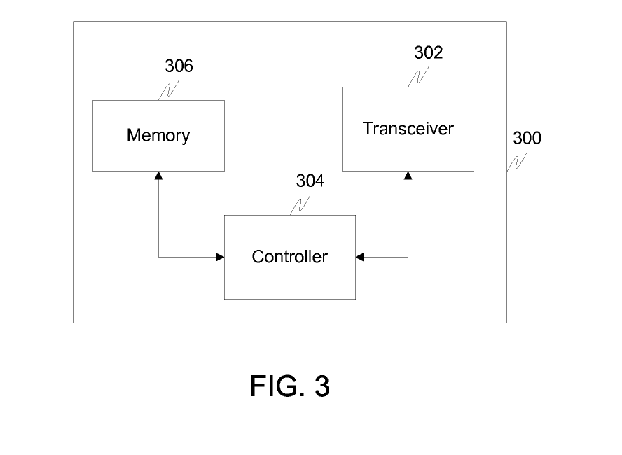

The first ID can be associated with the third ID by registering a contact address of the first device 202 and thus of the first ID with the third ID in a server 210, which is located in or is associated with the second communication network 104. The contact address may be the first ID of the first device 202 or just may include the first ID. The contact address of the first device 202 is the location or address of the first device 202 in the first communication network 102, where the first device 202 can be reached. Because the contact address is registered for the third ID, the contact address and thus the first ID can be obtained by querying the server 210 with the third ID as a key, or by using the third ID. Conversely the server 210 may also be queried with the first ID as a key to obtain the third ID. The server 210 may be a registrar associated with the second communication network 104. For example, the server 210 may be a SIP registrar. This is further explained in conjunction with FIG. 3.

To register the contact address for the third ID, the first device 202 in the first communication network 102 may generate a register message that includes the third ID in a ‘To’ header of the register message and the contact address corresponding to the first ID in a ‘Contact’ header of the register message. The first gateway 206 routes the register message to the second communication network 104, i.e., to the server 210. While routing the register message, the first gateway 206, may capture the association between the first ID and the third ID. This is further explained in conjunction with FIG. 3. The server 210 extracts the third ID and the contact address corresponding to the first ID from the register message received from the first gateway 206 and associates the third ID with the contact address corresponding to the first ID and thereby associating the first ID and the third ID. The server 210 may store the association between the first ID and the third ID in a location database 212 inside the server 210. The location database 212 also may be located outside the server 210.

In an embodiment of the invention, the server 210 may forward a copy of the register message to the second gateway 208. The second gateway 208 may capture the association between the first ID and the third ID from the register message. This is further explained in detail in conjunction with FIG. 3. The second gateway 208 may further store the association between the first ID and the third ID in a location server 214. The location server 214 may be one of a Home Location Registrar (HLR), an iDEN HLR, and an IP Multimedia Subsystem (IMS) Home Subscription Server (HSS). As a result of this, when the location server 214 is queried with the third ID, then the location server 214 sends a response indicating that the first device 202 that used the third ID in the second communication network 104 is on, near or behind the second gateway 208 in the second communication network 104. In an embodiment of the invention, the association between the first ID and the third ID may be configured inside one of, but not limited to, the first device 202, the first gateway 206, the server 210, and the second gateway 208 by a service provider.

In the first communication network 102, a first call is initiated from the first device 202, which is using the first ID, to and intended for the second device 204, which is using a second ID in the second communication network 104. The second ID may be one of, but not limited to, a UFMI, a temporary ID, a phone number, a fleet ID and an IMEI. In an embodiment of the invention, the initiation of the first call uses a call setup message, in which the ‘From’ header or the ‘Caller ID’ header includes the first ID as a Caller ID and the ‘Contact’ header includes the corresponding location or address at which the first device 202 can be reached. The first gateway 206 forwards the first call to the server 210, which stores the association between the first ID and the third ID. The server 210 substitutes the first ID with the third ID in the ‘From’ header of the first call based on the association between the first ID and the third ID. Hence the ‘From’ header now contains the third ID as the Caller ID. Because of the substitution, the second device 204 will be able to identify the first device 202, from the third ID used by the first device 202 in the second communication network 104. Since the third ID is associated with the second communication network 104, it can be interpreted by the second device 204. In contrast, the first ID may not be known in, or compatible with the second communication network 104. The third ID may also be stored in the address book of the second device 204.

Thereafter, the server 210 connects the first call to the second device 204 through the second gateway 208 or a proxy server (not shown in the FIG. 2). The server 210 identifies the first device 202 to the second device 204 using the third ID because of the substitution of the first ID with the third ID in the first call. Accordingly, the server 210 provides the third ID as a caller ID of the first device 202 to the second device 204.

The third ID, which is sent to the second device 204 by the server 210, for example, in the caller ID, may be used for a call back to the first device 202 from the second device 204. The caller ID may be displayed on the second device 204 and may be stored in the second device 204 for an automatic callback to the first device 202, if the first device 202 is the last caller. The caller ID may be the third ID itself. Alternately, the caller ID may be a text or a numeral corresponding to or indexed by the third ID. The display of a text or a numeral may be accomplished, for example, if a user of the second device 204 has stored the name of a person who uses or used the third ID, for example in a phone book. Therefore, providing the third ID to the second device 204 instead of the first ID, may display the name of the person using the first device 202 on the second device 204. A call back is a response dispatch or interconnect call initiated from a device in response to an originating call or a dispatch notification made from an originating device. The call back may be initiated by using a dedicated button for making dispatch calls on the device. Alternately, the call back may be made by using one of a key combination on the keypad of the device, menu item on the device, and an icon reserved for this purpose on the device. The call back may also be made by typing the caller ID into the keypad of the second device 204.

In another embodiment of the invention, the first gateway 206 may substitute the first ID with the third ID in the ‘From’ header of the first call based on the association between the first ID and the third ID, if the association between the first ID and the third ID is stored in the first gateway 206. Thereafter, the first gateway 206 connects the first call to the second device 204 through the second gateway 208, possibly via the server 210, and identifies the first device 202 to the second device 204 using the third ID because of the substitution of the first ID with the third ID. The first gateway 206 may provide the third ID as a caller ID of the first device 202 to the second device 204. The caller ID maybe the third ID itself. Alternatively, if the first gateway 206 did not capture the association between the first ID and the third ID while sending the register message to the server 210, then the first gateway 206 may query the server 210 with the first ID for information about the third ID associated with the first ID in the server 210. Thereafter, the first gateway 206 may substitute the first ID with the third ID in the ‘From’ header of the first call and connect the first call to the second device 204.

In another embodiment of the invention, the association between the first ID and the third ID is captured by the second gateway 208 from the copy of the register message forwarded by the server 210. In this embodiment, the first gateway 206 forwards the first call to the second gateway 208, possibly via the server 210. The second gateway 208 substitutes the first ID with the third ID in the ‘From’ header or in the ‘Caller ID’ header of the first call, based on the association between the first ID and the third ID stored in the second gateway 208. Thereafter, the second gateway 208 connects the call to the second device 204 and provides the caller ID corresponding to the third ID to the second device 204. The caller ID maybe the third ID itself.

Similarly, in the second communication network 104 a second call may be initiated from the second device 204 to and intended for the first device 202, using the third ID which the first device 202 used in the second communication network 104 before migrating to the first communication network 102. For this, a proxy server (not shown in the FIG. 2) for the second device 204 queries the location server 214 associated with the second communication network 104 for a contact address or for the location of the first device 202, using the third ID as a key. As the first device 202 has migrated or roamed to the first communication network 102, the location server 214 may indicate that the first device 202 is currently located on, near or behind the second gateway 208. The call is therefore routed to the second gateway 208. The second gateway 208 may then obtain the contact address for the third ID from the location server 214. After obtaining the contact address of the first device 202 migrated to the first communication network 102, the second gateway 208 connects the call to the first device 202 through the first gateway 206, possibly via the server 210.

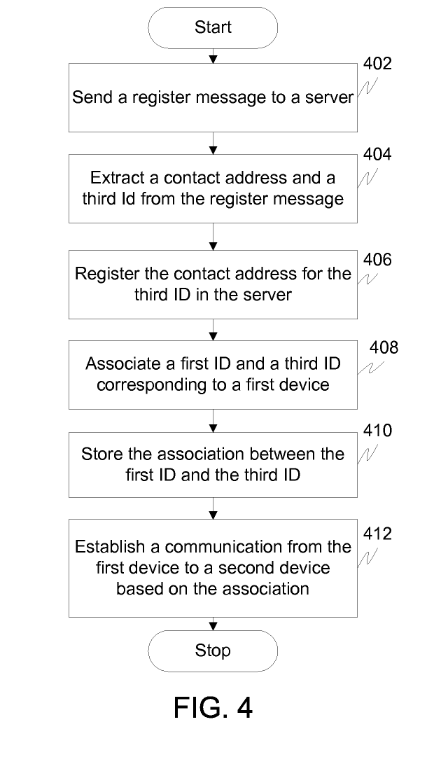

In another embodiment of the invention, the second gateway 208 may query the server 210 with the third ID to obtain the contact address of the first device 202. The server 210 provides the contact address of the first device 202 to the second gateway 208 based on the association of the third ID with the contact address corresponding to the first ID stored in the location database 212. Thereafter, based on the contact address of the first device 202, the second gateway 208 connects the second call to the first device 202 migrated to the first communication network 102 through the first gateway 206. This is further explained in conjunction with FIG. 4.

FIG. 3 is a block diagram showing an apparatus 300 for facilitating communication between the first device 202 in the first communication network 102 and the second device 204 in the second communication network 104 according to an embodiment of the invention. The first device 202 or the user of the first device 202 was identified by the third ID in the second communication network 104 to communicate with devices in the second communication network 104 and after migration or roaming to the first communication network 102, the first device 202 uses a first ID in the first communication network 102 to communicate with devices in the first communication network 102. Further, the second device 204 uses a second ID in the second communication network 104 to communicate with other devices in the second communication network 104.

The apparatus 300 includes a transceiver 302, a controller 304, and a memory 306. The transceiver 302 receives calls and/or messages from and transmits calls and/or messages to other network elements in the first communication network 102 and the second communication network 104. The transceiver 302 is adaptively coupled to the controller 304. In an embodiment of the invention, the apparatus 300 is the server 210. In this embodiment, the transceiver 302 receives from the first gateway 206 a register message for the first device 202. The register message includes the third ID in the ‘To’ header of the register message and a contact address corresponding to the first ID in a ‘Contact’ header of the register message. The contact address may correspond to the first ID by including the first ID or may be the first ID itself. This has been explained in conjunction with FIG. 2.

The transceiver 302 in the server 210 forwards the register message to the controller 304. The controller 304 in the server 210 extracts the third ID and the contact address corresponding to the first ID from the register message received from the first gateway 206 and associates the third ID with the first ID by associating the third ID and the contact address corresponding to the first ID. The controller 304 stores the association between the first ID and the third ID in the memory 306 in the server 210. The controller 304 may store the association between the first ID and the third ID in a network element corresponding to one of the first communication network 102 and the second communication network 104. The network element, for example, may be the first gateway 206 or the second gateway 208. The controller 304 may store the association between the first ID and the third ID in a location database inside the apparatus 300. The location database may also be located outside the apparatus 300. The transceiver 302 in the server 210 may forward a copy of the register message to the second gateway 208 in the second communication network 104, which may capture the association between the first ID and the third ID from the register message.

In another embodiment of the invention, the apparatus 300 is the first gateway 206. In this embodiment, the transceiver 302 in the first gateway 206 receives the register message for the first device 202. The transceiver 302 in the first gateway 206 forwards the register message to the controller 304 in the first gateway 206, which captures the association between the first ID and the third ID from the register message and stores the association in the memory 306. Thereafter, the transceiver 302 transmits the register message to the server 210. Similarly, the apparatus 300 may be the second gateway 208, the transceiver 302 in the second gateway 208 receives the register message for the first device 202. The transceiver 302 in the second gateway 208 forwards the register message to the controller 304 in the second gateway 208, which captures the association between the first ID and the third ID from the register message and stores the association in the memory 306.

FIG. 4 is a flowchart of a method of communication between the first device 202 in the first communication network 102 and a second device 204 in the second communication network 104 according to an embodiment of the invention. The first communication network 102 is a packet based network that supports data transfer, interconnect calls, and dispatch calls. The second communication network 104 is a network that supports half duplex dispatch calls and interconnect calls.

The first device 202 is identified by a third ID in the second communication network 104 to communicate with devices in the second communication network 104 and after migration or roaming, the first device 202 uses a first ID in the first communication network 102 to communicate with devices in the first communication network 102. This has been explained in conjunction with FIG. 2. The second device 204 uses a second ID in the second communication network 104. Examples of the first ID, the second ID, and the third ID have been explained in FIG. 2.

To enable the first device 202 in the first communication network 102 to communicate with devices in the second communication network 104, the controller 304 in the first gateway 206 sends 402 a register message to the server 210. The register message includes a contact address in a ‘Contact’ header of the register message and the third ID in a ‘To’ header of the register message. Therefore, the register message registers the contact address for the third ID. The contact address corresponds to the first ID and may include the first ID or may be the first ID itself.

When the register message is received by the transceiver 302 in the server 210, the controller 304 in the server 210 extracts 404 the contact address from the ‘Contact’ header and the third ID from the ‘To’ header in the register message. Thereafter, the controller 304 registers 406 the contact address for the third ID in the server 210. The registering of the contact address for the third ID enables the controller 304 to associate 408 the first ID used by the user of the first device 202 in the first communication network 102 with the third ID.

The controller 304 in the server 210 stores 410 the association between the first ID and the third ID in the location database 212 inside the server 210 in response to registering the contact address with the server 210. The location database 212 may also be located outside the server 210. As a result of this, the contact address of the first device 202 corresponding to the first ID can be obtained by querying the server 210 or the location database 212 using the third ID.

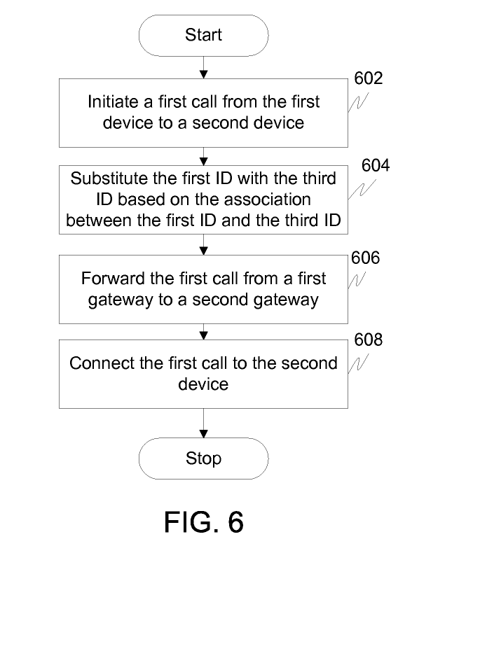

While sending the register message, the controller 304 in the first gateway 206 may capture the association between the first ID and third ID and store it in the memory 306 in the first gateway 206. In another embodiment of the invention, the transceiver 302 in the server 210 may forward a copy of the register message to the second gateway 208. The controller 304 in the second gateway 208 captures the association between the first ID and the third ID and stores the association in the location server 214 or in the memory 306 of second gateway 208. As a result of this, each of the first gateway 206, the second gateway 208, and the location server 214 can be queried with the third ID to obtain the location of the first device 202, which corresponds to the first ID. This is further explained in detail in conjunction with FIG. 6. The association between the first ID and the third ID may also be configured in the first gateway 206 and the second gateway 208 by a service provider.

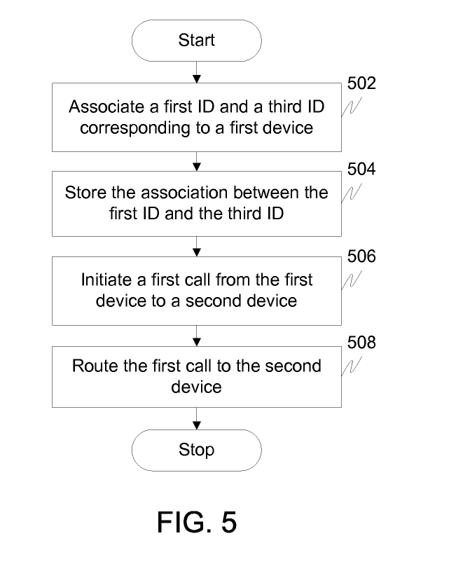

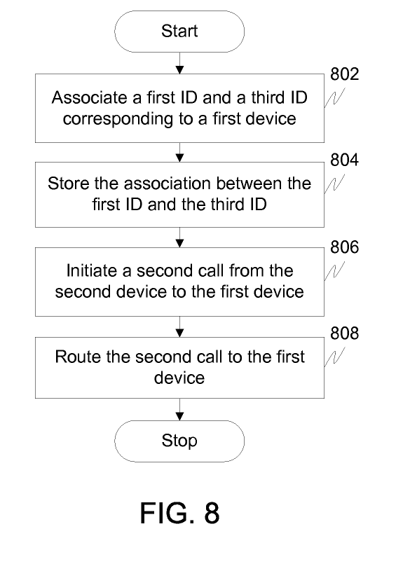

Thereafter, one of the first gateway 206 and the second gateway 208 establishes 412 a communication from the first device 202 to the second device 204 based on the association between the first ID and the third ID. This is further explained in conjunction with FIG. 5 and FIG. 8. The first device 202 may be the replacement of a third device in the second communication network 104. The third device is identified in the second communication network 104 by the third ID.

FIG. 5 is a flowchart of a method for establishing a communication between the first device 202 and the second device 204 according to an embodiment of the invention. The controller 304 in the server 210 associates 502 the first ID and the third ID corresponding to the first device 202. Thereafter, the controller 304 in the server 210 stores 504 the association between the first ID and the third ID. The first device 202 in the first communication network 102 initiates 506 a first call using the first ID to identify itself to the second device 204, which is using the second ID to identify the second device 204 in the second communication network 104. The first call is initiated using a call setup message, in which a ‘From’ header or a ‘Caller ID’ header includes the first ID and a ‘Contact’ header includes the contact address corresponding to the first ID at which the first device 202 can be reached.

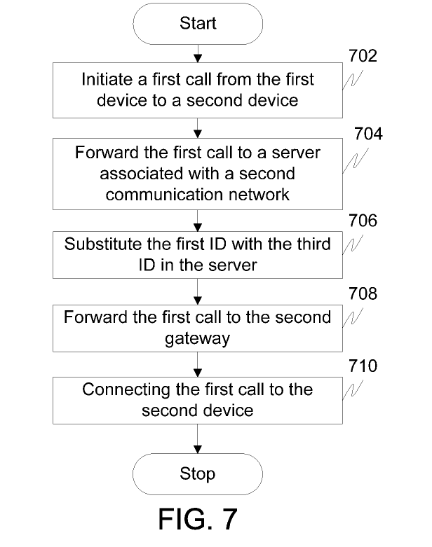

The first gateway 206 routes 508 the first call to the second device 204 in the second communication network 104 through the second gateway 208 and/or a proxy server in the second communication network 104. The first ID is substituted with the third ID in the ‘From’ header of the first call based on the association between the first ID and the third ID, so that the second device 204 can identify the first device 202 because the third ID used by the first device 202 to identify itself in the second communication network 104 is associated with the second communication network 104 and can be interpreted by the second device 204. In contrast, the first ID may not be known or usable in the second communication network 104. The first device 202 is identified to the second device 204 using the third ID because of the substitution of the first ID with the third ID in the first call. This is further explained in detail in conjunction with FIG. 6 and FIG. 7.

FIG. 6 is a flowchart of a method for routing a first call from the first device 202 to the second device 204 according to an embodiment of the invention. After execution of steps 502 and 504 listed in the FIG. 5, the first device 202 in the first communication network 102 initiates 602 the first call using the first ID to identify itself to the second device 204, which is using the second ID to identify itself in the second communication network 104. The controller 304 in the first gateway 206 substitutes 604 the first ID with the third ID in the ‘From’ header or a “Caller ID” header of the first call based on the association between the first ID and the third ID stored in the first gateway 206, so that the second device 204 can identify the first device 202 because the third ID used by the first device 202 to identify itself in the second communication network 104 is associated with the second communication network 104 and can be interpreted by the second device 204. In contrast, the first ID may not be known or usable in the second communication network 104. As described above, the first gateway 206 captured the association between the first ID and the third ID while forwarding the register message to the server 210 for registering the contact address corresponding to the first ID for the third ID.

The transceiver 302 in the first gateway 206 forwards 606 the first call to the second gateway 208 or a proxy server associated with the second communication network 104. The second gateway 208 connects 608 the first call to the second device 204 and identifies the first device 202 to the second device 204 using the third ID because of the substitution of the first ID with the third ID in the first call at the first gateway 206. Accordingly, the second gateway 208 provides the third ID as a caller ID of the first device 202 to the second device 204. The third ID, which is provided to the second device 204 by the server 210 in the caller ID, may be used for a call back to the first device 202 from the second device 204. The caller ID may be displayed on the second device 204 and may be stored in the second device 204 for an automatic callback to the first device 202.

In an embodiment of the invention, the second gateway 208 may substitute the first ID with the third ID in first call based on the association between the first ID and the third ID stored in the second gateway 208. The second gateway 208 stores the association between the first ID and the third ID, when the transceiver 302 in the server 210 sends a copy of the register message, which is used for registering the contact address corresponding to the first ID with the third ID in the server 210, to the second gateway 208. The second gateway 208 further may store the association between the first ID and the third ID in the location server 214. The second gateway 208 connects the first call to the second device 204 through a proxy server and identifies the first device 202 to the second device 204 using the third ID because of the substitution of the first ID with the third ID in the first call. As the call is connected to the second device 204 through the second gateway 208 and/or a proxy server associated with the second communication network 104, it may seem to the second device 204 that the first device 202 is on, near or behind the second gateway 208 and/or proxy server.

FIG. 7 is a flowchart of a method for routing the first call from the first device 202 to the second device 204 according to another embodiment of the invention. After performing steps 502 and 504 listed in the FIG. 5, the first device 202 in the first communication network 102 initiates 702 the first call using the first ID to identify itself to the second device 204, which is using the second ID to identify itself in the second communication network 104. The transceiver 302 in the first gateway 206 forwards 704 the first call to the server 210.

Thereafter, the controller 304 in the server 210 substitutes 706 the first ID with the third ID in the ‘From’ header or a “Caller ID” header of the first call based on the association between the first ID and the third ID stored in the location database 212 in the server 210. Thus, the second device 204 can identify the first device 202 because the third ID used by the first device 202 to identify itself in the second communication network 104 is associated with the second communication network 104 and can be interpreted by the second device 204. In contrast, the first ID may not be known or usable in the second communication network 104. After the substitution, the transceiver 302 in the server 210 forwards 708 the first call to the second gateway 208 or a proxy server associated with the second communication network 104. The second gateway 208 connects 710 the first call to the second device 204 and identifies the first device 202 to the second device 204 using the third ID because of the substitution of the first ID with the third ID in the first call at the server 210. Accordingly, the second gateway 208 provides the third ID as a caller ID of the first device 202 to the second device 204.

FIG. 8 is a flowchart of a method for establishing a communication between the first device 202 and the second device 204 according to another embodiment of the invention. The controller 304 in the server 210 associates 802 the first ID and the third ID corresponding to the first device 202. Thereafter, the controller 304 in the server 210 stores 804 the association between the first ID and the third ID. These steps have been explained in detail in conjunction with FIG. 4. The second device 204, which is using the second ID in the second communication network 104, initiates 806 a second call for the first device 202 using the third ID to identify the first device 202. The third ID may be provided to the second device 204 during the first call from the first device 202 to the second device 204. In an embodiment of the invention, the third ID is pre-stored in the second device 204. The second call may be a call back initiated in response to connecting of the first call. The second call may be a new call that is not dependent on the connecting of the first call.

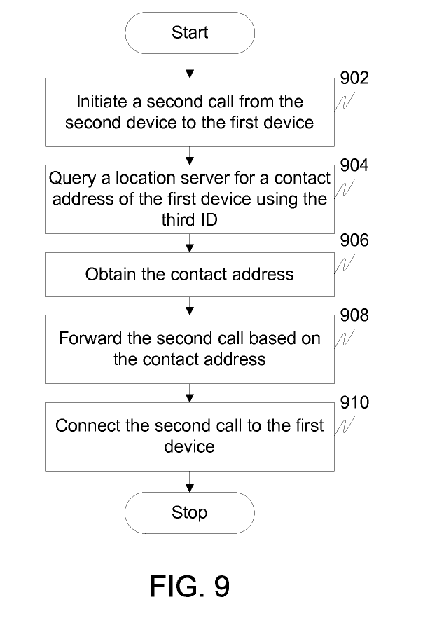

In an embodiment of the invention, the second gateway 208 captures the association between the first ID and the third ID from a copy of the register message received from the server 210 and stores the association in the location server 214. In this embodiment, the location server 214 is queried using the third ID to obtain the contact address or the location of the first device 202 in response to initiation of the second call. The contact address may include the first ID or may be the first ID itself. This is explained in detail in conjunction with FIG. 9. In another embodiment of the invention, the association between the first ID and the third ID is stored in the server 210 only. In this embodiment, the second device 204 forwards the second call to the second gateway 208. Thereafter, the second gateway 208 queries the server 210 to obtain the contact address of the first device 202 corresponding to the first ID, using the third ID.

After obtaining the contact address based on the association between the first ID and the third ID, the second gateway 208 routes 808 the second call to the first device 202 based on the association between the first ID and the third ID, obtained from the location server 214.

FIG. 9 is a flowchart of a method for routing the second call from the second device 204 to the first device 202 according to an embodiment of the invention. After performing 802 and 804 listed in the FIG. 8, the second device 204, which is using the second ID in the second communication network 104, initiates 902 a second call for the first device 202 using the third ID to identify the first device 202.

In response to initiating the second call, the second device 204 or a proxy for the second device 204 queries 904 the location server 214 for the contact address or location of the first device 202 corresponding to the first ID using the third ID. As the first device 202 has migrated or roamed to the first communication network 102, therefore, the location server 214 may indicate that the first device 202 is currently located on, near or behind the second gateway 208.

After obtaining the contact address or location for the third ID from the location server 214, the second device 204 or a proxy server associated with the second communication network 104, forwards 908 the second call to the second gateway 208. Thereafter, the second gateway 208 connects 910 the second call to the first device 202 through the first gateway 206 based on the contact address of the first device 202, which corresponds to the first communication network 102. The second gateway 208 can obtain the contact address of the first device 202 by querying the server 210 or the location database 212.

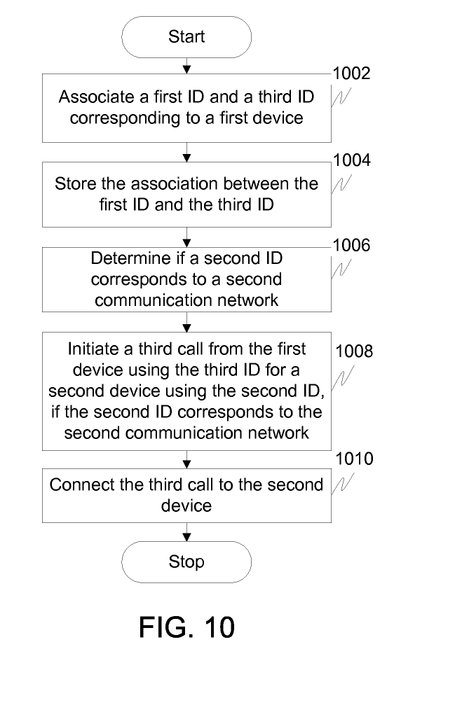

FIG. 10 is a flowchart of a method for establishing a communication between the first device 202 and the second device 204 according to another embodiment of the invention. The controller 304 in the server 210 associates 1002 the first ID and the third ID corresponding to the first device 202. While sending a register message to the server 210 to associate the first ID and the third ID, the controller 304 in the first gateway 206 may capture the association between the first ID and the third ID from the register message. The controller 304 in the first gateway 206 may store 1004 the association between the first ID and the third ID in the first device 202. The first gateway 206, the server 210, and the second gateway 208 may also capture and store the association between the first ID and the third ID in the first device 202 during the first call.

In an embodiment, before initiating a third call to and intended for the second device 204, the first device 202 determines 1006 if the second ID used by the second device 204 corresponds to the second communication network 104. If the second ID corresponds to the second communication network 104, then the first device 202 initiates 1008 the third call from the first device 202 using the third ID to identify the first device to the second device 204, which is using the second ID. Thus, the first device 202 uses the third ID to identify itself to the second device 204. The first device 202 connects 1010 the third call to the first device 202 through the first gateway 206 and the second gateway 208 thus providing a caller ID corresponding to the third ID to the second device 204. The caller ID may be the third ID itself or may include the third ID.

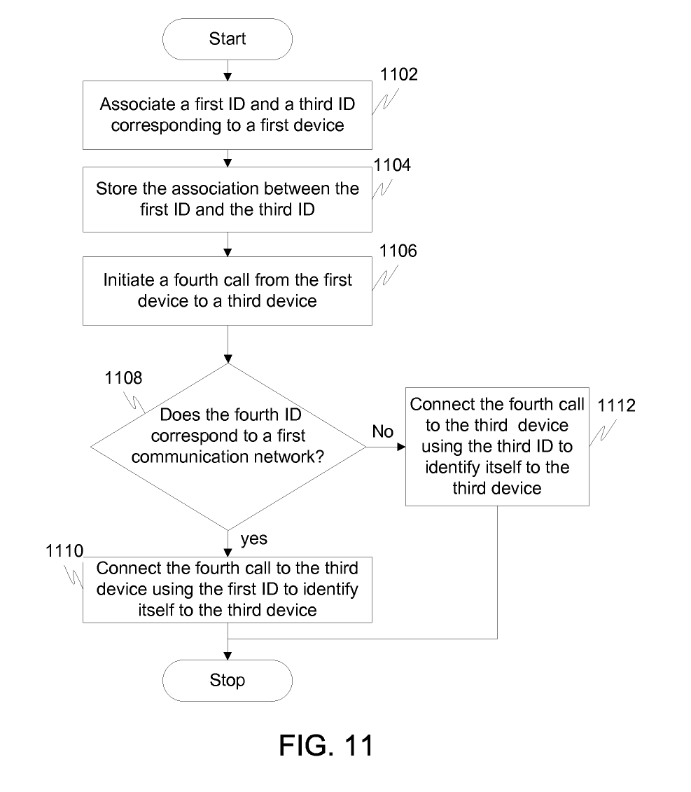

FIG. 11 is a flowchart of a method for establishing communication between the first device 202 and a third device (not shown in the FIG. 2) according to an embodiment of the invention. The third device is identified by a fourth ID. The fourth ID, for example, may be a 3G ID, such as a SIP URI, a SIPS URI, an absolute URI, an IP address. The first device 202 can itself associate 1102 the first ID and the third ID, which may be enabled by configuration or provisioning in the first device 202. The first device 202 stores 1104 the association between the first ID and the third ID in its memory.

The first device 202 initiates 1106 a fourth call to and intended for the third device. Thereafter, the first device 202 performs 1108 a check to determine if the fourth ID used to identify the third device corresponds to the first communication network 102. If the fourth ID corresponds to the first communication network 102, then the first device 202 connects 1110 the fourth call to the third device using the first ID to identify itself to the third device. The first device 202 may connect the fourth call to the third device through the gateway 206. The first device 202 provides a caller ID corresponding to the first ID to the third device. The caller ID may be the first ID itself or may include the first ID.

Referring back to 1108, if the fourth ID does not correspond to the first communication network 102, then it implies that the fourth ID corresponds to the second communication network 104. Thus, the first device 202 connects 1112 the fourth call to the third device using the third ID to identify the first device 202 to the third device. The first device 202 may connect the fourth call to the third device through at least one of the first gateway 206 and the second gateway 208. The first device 202 provides a caller ID corresponding to the third ID to the third device. The caller ID may be the third ID itself or may include the third ID.

In other words, FIG. 10 and FIG. 11 illustrate how the first device 202 can establishing a communication with an other device that uses an other ID if the first device 202 stores the association between first ID and the third ID, where the first ID is used to identify the first device 202 in the first communication network 102 and where the third ID is used to identify the first device 202 in the second communication network 104. When the first device initiates a call to the other device, the first device 202 first determines whether the other ID of the other device corresponds to the first communication network 202 or to the second communication network 204. Then the first device 202 sets up the call using the first ID to identify itself when determining that the other ID corresponds to the first communication network 102; and using the third ID to identify itself when determining that the other ID corresponds to the second communication network 104. Next the first device 202 connects the call to the other device, possibly directly to the second device 208 inside the first communication network 104 or alternatively via the first gateway 206.

Various embodiments of the invention provide methods and systems for communication between a first device in a first communication network and a second device in a second communication network. The first device uses a first ID in the first communication network and is identified in the second communication network by a third ID. The second device uses a second ID in the second communication network. An association is created between the first ID and the third ID. Based on the association between the first ID and the third ID, a first device, which initiates a call using the first ID to the second device, is identified to the second device using the third ID. As a result of this, the second device can call back the first device using the third ID provided the call connected from the first device to the second device.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of communication between a first device migrated from a second communication network to a first communication network and a second device in the second communication network, the first device using a first Identifier (ID) in the first communication network, the second device using a second ID in the second communication network, the method comprising:
associating the first ID and a third ID, wherein the third ID identifies the first device in the second communication network;
storing the association between the first ID and the third ID; and
establishing a communication from the first device to the second device based on the association between the first ID and the third ID.

2. The method of claim 1, further comprising registering a contact address for the third ID in a server associated with the second communication network, wherein the contact address corresponds to the first ID.

3. The method of claim 1, wherein establishing the communication comprises:
initiating a first call from the first device using the first ID to the second device using the second ID, wherein the first device uses the first ID to identify the first device to the second device; and
routing the first call to the second device, wherein the first device is identified to the second device using the third ID.

4. The method of claim 3, wherein routing the first call comprises:
substituting the first ID with the third ID based on the association between the first ID and the third ID in at least one of a first gateway associated with the first communication network and a second gateway associated with the second communication network;
forwarding the first call from the first gateway to the second gateway; and
connecting the first call to the second device, wherein a caller ID corresponding to the third ID is provided to the second device.

5. The method of claim 3, wherein routing the first call comprises:
forwarding the first call to a server associated with the second communication network, wherein the server stores the association between the first ID and the third ID;
substituting the first ID with the third ID in the server based on the association between the first ID and the third ID;
forwarding the first call from the server to a gateway; and
connecting the first call to the second device, wherein a caller ID corresponding to the third ID is provided to the second device.

6. The method of claim 3, wherein establishing the communication further comprises:
initiating a second call from the second device to the first device using the third ID to identify the first device; and
routing the second call to the first device based on the association between the first ID and the third ID.

7. The method of claim 6, wherein routing the second call comprises:
querying a server for a contact address of the first device using the third ID;
obtaining the contact address from the server;
forwarding the second call based on the contact address; and
connecting the second call to the first device.

8. The method of claim 1, wherein the association between the first ID and the third ID is stored in a network element of at least one of the first communication network and the second communication network.

9. The method of claim 1, wherein the association between the first ID and the third ID is stored in the first device.

10. The method of claim 9, wherein establishing the communication comprises:
determining if the second ID corresponds to the second communication network;
initiating a third call from the first device to the second device using the second ID, wherein the first device uses the third ID to identify the first device to the second device if the second ID corresponds to the second communication network; and
connecting the third call to the second device, wherein a caller ID corresponding to the third ID is provided to the second device.

11. The method of claim 9, the method further comprising:
initiating a fourth call from the first device to a third device, the third device being identified by a fourth ID;
determining at the first device if the fourth ID corresponds to one of the first communication network and the second communication network;
connecting the fourth call to the third device using the first ID to identify the first device to the third device if the fourth ID corresponds to the first communication network; and
connecting the call to the third device using the third ID to identify the first device to the third device if the fourth ID corresponds to the second communication network.

12. The method of claim 1, further comprising replacing a third device with the first device, the third device being identified in the second communication network by the third ID.

13. An apparatus for facilitating communications between a first device in a first communication network and a second device in a second communication network, the first device using a first Identifier (ID) in the first communication network, the second device using a second ID in the second communication network, the apparatus comprising:
a memory;
a transceiver; and
a controller, the transceiver adaptively coupled to the controller, the controller being configured to:
associate the first ID and a third ID, wherein the third ID identifies the first device in the second communication network;
store the association between the first ID and the third ID; and
establish a communication from the first device to the second device based on the association between the first ID and the third ID.

14. The apparatus of claim 13, wherein the controller is further configured to:
store the association between the first ID and the third ID in an element corresponding to at least one of the first communication network and the second communication network.

15. A system for communicating between a first communication network and a second communication network, the system comprising:
a first device using a first ID in the first communication network, the first device being identified by a third ID in the second communication network, the first ID being associated with the third ID;
a second device using a second ID in the second communication network;
a first gateway associated with the first communication network, the first gateway being configured to route a first call to the second device, the first call being initiated from the first device using the first ID to identify the first device to the second device, the first device being identified to the second device using the third ID; and
a second gateway associated with the second communication network, the second gateway being configured to route a second call to the first device based on the association between the first ID and the third ID, the second call being initiated from the second device to the first device using the third ID to identify the first device.

16. The system of claim 15, wherein the first gateway is further configured to:
substitute the first ID with the third ID based on the association between the first ID and the third ID; and
connect the first call to the second device through the second gateway, wherein a caller ID corresponding to the third ID is provided to the second device.

17. The system of claim 15, wherein the second gateway is further configured to:
substitute the first ID with the third ID based on the association between the first ID and the third ID; and
connect the first call to the second device, wherein a caller ID corresponding to the third ID is provided to the second device.

18. The system of claim 15 further comprising a server associated with the second communication network, wherein the server stores the association between the first ID and the third ID.

19. The system of claim 18, wherein the server stores the association between the first ID and the third ID as a contact address of the first device, the contact address registered for the third ID.

20. The system of claim 18, wherein the server is configured to:
substitute the first ID with the third ID based on the association between the first ID and the third ID; and
connect the first call to the second device through the second gateway.

21. The system of claim 15, wherein the second gateway is further configured to:
query a server for a contact address of the first device using the third ID, wherein the contact address corresponds to the first ID;
obtain the contact address from the server; and
connect the second call based on the contact address to the first device through the first gateway.
